(19) United States
(12) Patent Application Publication
(10) Pub. No.: US 2007/0140708 A1
(43) Pub. Date: Jun. 21, 2007

(54) IMAGE FORMING APPARATUS AND ASSOCIATED METHODOLOGY OF INDICATING AN AVAILABLE LEVEL OF IMAGING RESOURCES

(76) Inventors: Masahiro Yonekawa, Machida City (JP); Ryota Yano, Aoba Ward (JP); Hiroshi Obara, Yokohama City (JP); Masaaki Kabumoto, Yachiyo City (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/610,853

(22) Filed: Dec. 14, 2006

(30) Foreign Application Priority Data
Dec. 19, 2005 (JP) 2005-365561

(51) Int. Cl. G03G 15/00

(52) U.S. Cl. 399/12

(57) ABSTRACT

An image forming apparatus such as an ink jet printer or a laser beam printer include an ink or toner cartridge loading portion and a display portion to show the remaining amount of the ink or the toner. The ink or toner cartridge loaded in the ink or toner cartridge loading portion and the display portion are viewable together at once.

### BACKGROUND OF THE INVENTION

The present advancements relate to an image forming apparatus such as a printer configured to recognize a remaining amount of ink or toner.

The “background” description provided herein is for the purpose of generally presenting the context of the inventions. Work of the presently named inventors, to the extent it is described in this background section, as well as aspects of the description which may not otherwise qualify as prior art at the time of filing, are neither expressly or impliedly admitted as prior art against the present inventions.

Conventionally, in an image forming apparatus such as an ink jet printer or a laser printer, a display, such as a liquid crystal display (LCD), is utilized to indicate a remaining amount of ink or toner. Some methods utilized to indicate a remaining amount of ink or toner are proposed.

Japanese Patent Laid-Open Application No. 2005-001149 describes a manner of indicating a remaining amount of ink of an ink jet printer that employs an ink head with an ink tank. The ink jet printer supplies an ink from the ink cartridge to the ink tank. The ink tank provides to the ink head, and, the ink head discharges the ink to print. A display of a host computer, at least while the ink jet printer is working, indicates illustrations of the remaining amount of the ink in the ink tank and the ink cartridge.

By the illustrations, the remaining amount of ink in the ink tank and the ink cartridge are indicated. In this way, remaining amount of the ink in the ink tank and the ink cartridge are properly administrated by service personnel.

Japanese Patent No. 3229509 describes a conventional ink jet printer employing various types of ink cartridges and having an ink head or an ink tank. The ink jet printer indicates the remaining amount of the ink in the cartridge or in the ink tank according to a type of ink cartridge or ink tank. Thus, changing of the ink cartridge or the ink tank is determined based upon the type of new ink cartridge or new ink tank.

For example, if the new ink cartridge is a type of an ink cartridge having an ink head which discharges only black ink, a parameter is set for indicating the remaining amount of the ink in the cartridge. However, in an ink jet printer, the relationship between the ink cartridge and indication of the remaining amount of the ink in the cartridge is unclear. Due to the difficulty in corresponding the color alignment sequence of the ink cartridge and an indication on a that the color alignment sequence of the ink cartridge and indication were different. In this way the need for cartridge replacement was not easy to determine.

### SUMMARY OF EXEMPLARY ASPECTS OF THE INVENTIONS

In one aspect of the claimed advancements, an image forming apparatus is provided. The apparatus includes an ink or toner cartridge loading portion configured to receive an ink or toner cartridge. The ink or toner cartridge includes a viewable status portion for indicating a level of available ink or toner. A display portion graphically indicates the remaining amount of the ink or toner. The ink or toner cartridge viewable status portion and the display portion are simultaneously viewable.

In a further aspect of the claimed advancements, an image forming apparatus is provided and includes a loading structure for receiving an ink or toner cartridge. The ink or toner cartridge includes a viewable status portion which indicates the available amount of the toner or ink. A display graphically indicated the remaining amount of the ink or toner. The viewable status portion and the display are simultaneously viewable.

It is to be understood that both the foregoing general description of the exemplary aspects of the inventions and the following detailed description are exemplary, but are not restrictive, of the invention.

### BRIEF DESCRIPTION OF THE SEVERAL VIEWS OF THE DRAWINGS

A more complete appreciation of the present invention, and many of the attendant advantages thereof, will be readily obtained as the same becomes better understood by reference to the following detailed description when considered in connection with the accompanying drawings.

The accompanying drawings do not wholly represent or limit scope of the inventions embraced by this specification. The scope of the inventions embraced by this specification and drawings are defined by the words of the accompanying claims.

FIG. 1 is a perspective view of the ink jet printer according to an exemplary embodiment of the present invention;

FIG. 2 is a cross-section view showing an overall configuration of the inkjet printer according to FIG.1;

FIG. 3A is a front perspective view of the ink jet printer according to the exemplary embodiment of the present invention; and

FIG. 3B is an enlarged view of the display panel including indicators of remaining amounts of ink cartridges.

### DETAILED DESCRIPTION OF THE INVENTIONS

In the following, exemplary embodiments of the present inventions are described with reference to the accompanying drawings. It is noted that in the following description, an exemplary embodiment using an ink cartridge as an expendable portion is illustrated as an example. However, the presently described advancements are not limited to this embodiment, and for example, those skilled in the art will recognize that a toner bottle, an ink ribbon cartridge, a process cartridge that integrates components such as a developing unit and a photo conductor unit into a single unit, and other various types of expendable items, replaceable items, and replenishment items are used as an expendable portion that is installed and removed from an imaging apparatus or some other type of multi-function apparatus.

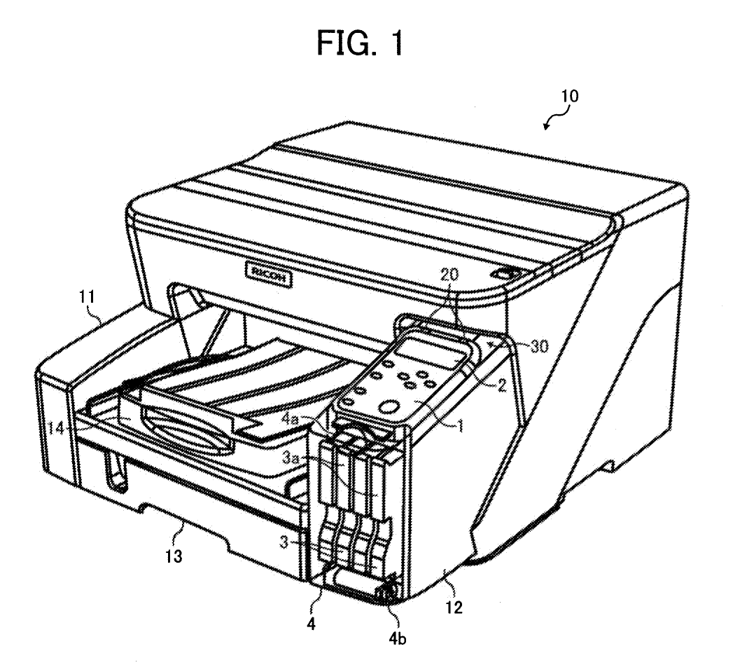

Referring now to FIG. 1, the imaging apparatus corresponds to an ink jet printer 10 having an operating portion 1 on the right side of the front portion of an apparatus main body 11 and the ink cartridge loading portion 12. The operating portion 1 includes a display 2 such as a liquid crystal display (LCD) is provided upward or obliquely upward and facing front of the imaging apparatus. The ink cartridge loading portion 12 provided as substantially box shaped accommodates four ink cartridges with the color alignment sequence of corresponding to four colors, Black (Bk), Cyan(C), Magenta (M), Yellow (Y), for example, from the left side of the apparatus main body 11. The color alignment sequence of the color of ink cartridge is not limited to this embodiment. The apparatus main body 11 includes a main ink jet printer structure printer, a paper feeder tray 13 which store a stack of papers, and paper delivery unit 14 which substantially covers the paper feeder tray 13 and is provided adjacent to the left side of the ink cartridge loading portion 12.

The ink cartridge loading portion 12 include an ink cartridge cover 4 which is translucent. If the cover is closed, the ink cartridges 3 are visible through the cover. The ink cartridges 3 have color indicative portions like a spine label. Of course, those skilled in the art recognize that. The color indicative portion of each ink cartridge is not limited to these embodiments. The cover can be provided as transparent, translucent, partially translucent, or including translucent window to make the ink cartridge visible to an operator.

A handle 4a and an axis 4b to open and close are provided to the ink cartridge cover 4.

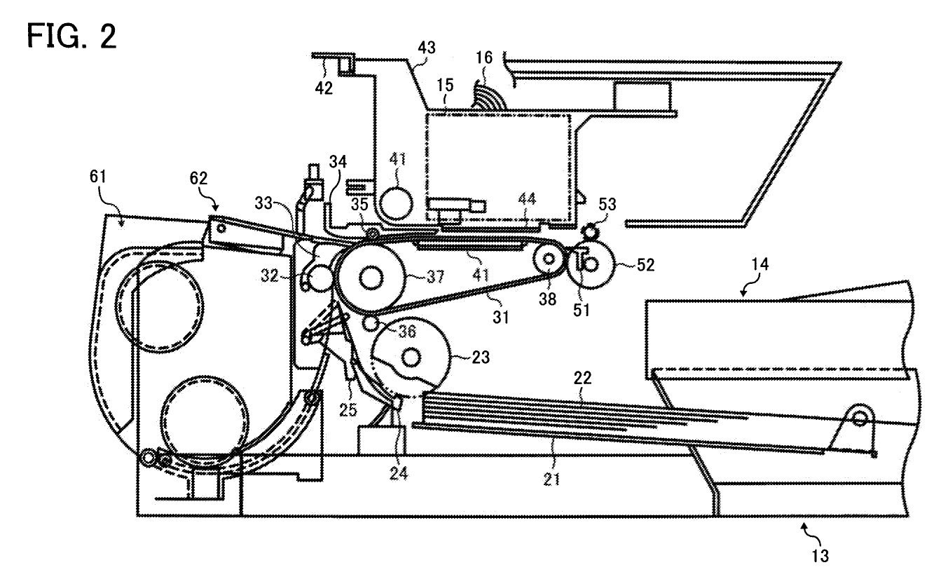

FIG. 2 is a cross-section view showing an overall configuration of the inkjet printer of FIG. 1.

The apparatus main body 1 includes a carriage 43 that is held by a guide rod 41 corresponding to a guide member that is supported by left and right side walls (not shown), and a stay 42 so that the carriage 43 may slide freely along a main scanning direction. The carriage 43 is driven by a main scanning motor (not shown) to realize scanning in the vertical direction to the cross-section.

The carriage 43 includes four recording heads 44 corresponding to ink jet heads that discharge ink in colors yellow (Y), cyan (C), magenta (M), and black (Bk), respectively.

The ink discharge openings of the recording heads 44 are arranged in a manner such that the ink discharge direction intersects the main scanning direction.

The inkjet heads used as the recording heads 44 include energy generating units for discharging ink. The energy generating units may correspond to a piezoelectric actuator (piezoelectric element), a thermal actuator providing an electrothermal conversion element such as a thermal resistor and using liquid phase change that is caused by film boiling, a shape memory alloy actuator using metal phase change that is caused by temperature change, or an electrostatic actuator using, electrostatic power, for example. In the exemplary embodiment, a head that provides the piezoelectric actuator as the energy generating unit is used.

Also, as the recording head 44, one ink jet head providing plural nozzles arranged in an array for discharging ink in the respective colors are used.

The carriage 43 also includes a sub tank 15 (liquid container) for each color for supplying ink to the recording head 44. Ink may be supplied to the sub tank 15 from the main tank (ink cartridge) 10 via an ink supply tube 16. Herein, each main tank 10 may accommodate ink in one of the colors yellow (Y), cyan (C), magenta (M), and black (Bk).

The paper delivery unit 13 includes a sheet stack unit (platen) 21 on which sheets 22 are stacked, and a paper feed unit including a paper feed member 23, a separation pad 24 positioned opposite to the paper feed member 23, and a guide 25. The paper feed member 23 is for feeding the sheets 22 from the sheet stack 21 one by one, and the separation pad 24 is made of material with a high friction coefficient and is forced toward the paper feed guide 23 side. The guide 25 carries the sheet 22 to a carrier unit.

The carrier unit is for carrying the sheet 22 supplied by the paper feed unit to the recording head 44. The carrier unit includes a carrier belt 31, a counter roller 32, a carrier guide 33, a press member 34, a pressure applying drum 35, and a charge roller 36. The sheet 22 sent from the paper feed unit is adhered to the carrier belt 31 by electrostatic force, and the sheet is held in between the carrier belt 31 and the counter roller 32 to be carried further into the carrier unit.

The carrier guide 33 changes the direction of the sheet 22 that is heading upward by approximately 90 degrees so that the sheet 22 are carried along the carrier belt 31, and the pressure applying drum 35 is forced toward the carrier belt 31 by the press member 34 member, and the charge roller 36 charges the surface of the carrier belt 31.

The carrier belt 31 is a round belt with no end that is held between a carrier roller 37 and a tension roller 38. The carrier belt 31 is rotated along a belt carrying direction (sub scanning direction). The charge roller 36 is arranged to be in contact with the surface of the carrier belt 31 to rotate according to the rotation of the carrier belt 31. At the inner side of the carrier belt 31, a guide member 41 is positioned at a region corresponding to a printing region of the recording head 44. The upper portion of the guide member 41 protrudes outward toward the recording head 44 with respect to the tangent line of the two rollers (i.e., carrier roller 37 and tension roller 38) supporting the carrier belt 31.

On the surface of the guide member 41 that is in contact with the inner surface of the carrier belt 31, plural trenches extending in a direction perpendicular to the carrying direction are formed so that the area of contact between the guide member 41 and the carrier belt 31 is reduced and the carrier belt 31 may move smoothly along the surface of the guide member 41. In this way, an image is recorded on the sheet 22 by the recording head 44, and the sheet 22 is carried to a paper delivery unit.

The paper delivery unit for discharging the sheet 22 includes a separator member 51, a paper delivery roller 52, and a paper delivery drum 53. The paper delivery unit 13 is positioned below the paper delivery roller 52 to receive the sheet 22 discharged from the paper delivery unit 13.

It is noted that a fair distance in height is provided from the point of contact between the paper delivery roller 52 and the paper delivery drum 53 to the position of the paper delivery unit 13 to increase the number of sheets that are stacked onto the paper delivery unit 13.

Also, a dual side printing paper feed unit 61 is detachably provided to the rear side of the apparatus main body 1. The sheet 22 having an image printed on one side is introduced into the dual side printing paper feed unit 61 through a reverse rotation of the carrier belt 31 so that the sheet 22 is flipped and provided into the carrier unit via the counter roller 32 and the carrier belt 31. It is noted that a manual paper feed part 62 is provided on the upper side of the dual side printing paper feed unit 61.

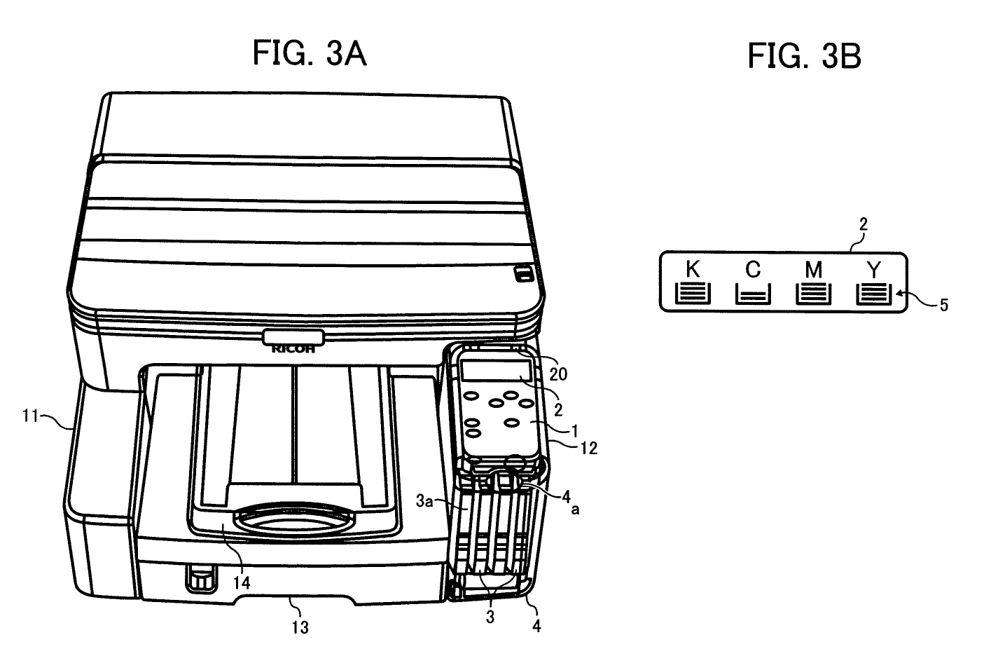

According to FIG. 3A, a display 2 as a liquid crystal display (LCD) indicates each remaining amount of the ink in the ink cartridges corresponding to four colors, Black (Bk), Cyan(C), Magenta (M), and Yellow (Y). According to FIG. 3, the display 2 indicates that the remaining amount of the ink of Cyan is lower than the remaining amount of the ink of other colors.

According to FIG. 1 and FIG. 3, the color alignment sequence of the ink cartridge and the ink cartridge loading portion correspond to the color alignment sequence of the indicators of each color on the display panel 2. As the indicators 5 of each color on the display panel 2 and the ink cartridges 3 of each colors are viewable together at once, a user of the ink jet printer easily recognize the relation of the indicators 5 of the remaining amount of the ink of each colors on the display panel 2 and the ink cartridges 3 of each colors.

Further, the indicators 5 of each color on the display panel 2 and the ink cartridges 3 of each color are viewable together at once, even if the ink cartridge cover 4 is closed.

Furthermore, as the color alignment sequence of the ink cartridges and the ink cartridge loading portion correspond to the color alignment sequence of the indicators of each colors on the display panel 2, the user can recognize instinctively the ink cartridge which is needed to change (According to FIG. 2, the ink cartridge which is needed to change is the cyan cartridge).

The indicators 5 of each color on the display panel 2 and the ink cartridges 3 of each colors are viewable together at once, a user of the ink jet printer easily recognize the relation of the indicators 5 of the remaining amount of the ink of each colors on the display panel 2 and the ink cartridges 3 of each colors.

An indicator 20 including LED (Light Emitting Diode) is provided to the apparatus main body 11 over the operating portion 1.Further, according to FIG. 1 and FIG. 3A, a overhang portion 30 is provided to the apparatus main body 11 over the indicator 20 including LED (Light Emitting Diode). The overhang portion 30 makes a shadow on the indicator 20 including LED (Light Emitting Diode). Thus, the indicator 20 including LED (Light Emitting Diode) is provided in the shadow, the user can recognize a light of the LED (Light Emitting Diode) clearly. According to FIG. 2, the overhang portion 30 is provided just over the indicator 20 including LED (Light Emitting Diode). However, the exemplary embodiments are not limited to this exemplary structure as long as the overhang portion 30 is provided merely above the indicator 20 including LED (Light Emitting Diode). The operating portion 1 and the indicator 20 including LED (Light Emitting Diode) is provided upward.

The overhang portion 30 is provided to the apparatus main body 11 over the light (a light axis) of LED (Light Emitting Diode), a light from outside along or around of the light axis light indirectly. Even though under bright room ramp, as the indicator 20 including LED (Light Emitting Diode) is provided in a shadow of the overhang portion 30 of the apparatus main body 11, the user easily recognizes that the LED (Light Emitting Diode) works. Additionally, the light axis faces to the user; the user easily recognizes that the LED (Light Emitting Diode) works.

The present inventions are applicable to not only the ink jet printer but also, for example, a facsimile machine, a copier, and a multifunctional peripheral that serves as a printer, a facsimile machine, and a copier. In addition, the present invention is applicable to an apparatus that discharges liquid other than ink, such as resist and DNA samples. The present inventions are not limited to these embodiments, and variations and modifications may be made without departing from the scope of the present invention.

The present application claims priority to Japanese Patent Application No. 2005-365561 filed in the Japanese Patent Office on Dec. 19, 2005, the disclosure of which is incorporated herein by reference.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. An image forming apparatus comprising:
an ink or toner cartridge loading portion configured to receive an ink or toner cartridge, the ink or toner cartridge including a viewable status portion for indicating a level of available ink or toner; and
a display portion configured to graphically indicate the remaining amount of the ink or the toner,
wherein the ink or toner cartridge viewable status portion and the display portion are simultaneously viewable.

2. The image forming apparatus as claimed in claim 1, wherein the ink or toner cartridge loading portion includes a door for enclosing the loading portion, and the door is translucent.

3. The image forming apparatus as claimed in claim 1, wherein the ink or toner cartridge loading portion includes door for enclosing the loading portion, and the door includes a translucent portion.

4. The image forming apparatus as claimed in claim 1, wherein the ink or toner cartridge loading portion accommodates plural ink or toner cartridges for plural colors, the display portion includes a corresponding indicators to indicate a remaining amount of the ink or the toner of a respective cartridge, the color alignment sequence of the ink or toner cartridge loading portion corresponding to the color alignment sequence of the indicators.

5. The imaging forming apparatus as claimed in claim 4, wherein the display portion is located at an uppermost surface of the image forming apparatus above the ink or toner cartridge loading portion.

6. The image forming apparatus as claimed in claim 5, further comprising: an operating portion located above the ink or toner cartridge loading portion configured to control image forming operations.

7. An image forming apparatus comprising:
loading means for receiving an ink or toner cartridge, the ink or toner cartridge including a viewable status portion for indicating an available amount of toner or ink; and
a display configured to graphically indicate the remaining amount of the ink or the toner,
wherein the viewable status portion and the display are simultaneously viewable.

8. An image forming apparatus comprising:
an ink or toner cartridge as the first element, the ink or toner cartridge including a viewable status portion for indicating a level of available ink or toner;
an ink or toner cartridge loading portion configured to receive an ink or toner cartridge; and
a display portion configured to graphically indicate the remaining amount of the ink or the toner;
wherein the ink or toner cartridge viewable status portion and the display portion are simultaneously viewable.

9. The image forming apparatus as claimed in claim 7, wherein the ink or toner cartridge loading portion includes a door for enclosing the loading portion, and the door is translucent.

10. The image forming apparatus as claimed in claim 7, wherein the ink or toner cartridge loading portion includes a door for enclosing the loading portion, and the door includes a translucent portion.

11. The image forming apparatus as claimed in claim 7, wherein the ink or toner cartridge loading portion accommodates plural ink or toner cartridges for plural colors, the display portion includes a corresponding indicators to show a remaining amount of the ink or the toner of a respective cartridges.

12. The imaging forming apparatus as claimed in claim 10, wherein the display portion is located at an uppermost surface of the image forming apparatus above the ink or toner cartridge loading portion.

13. The image forming apparatus as claimed in claim 11, further comprising: an operating portion located above the ink or toner cartridge loading portion configured to control image forming operations.
